(19) United States
(12) Patent Application Publication
(10) Pub. No.: US 2008/0268963 A1
(43) Pub. Date: Oct. 30, 2008

(54) Multi-mode protective device for portable video players

(76) Inventor: Shawn Deutchman, Philomath, OR (US)

Correspondence Address: SCHACHT LAW OFFICE, INC., SUITE 202, 2801 MERIDIAN STREET, BELLINGHAM, WA, 98225-2412, US

(21) Appl. No.: 11/880,364

(22) Filed: Jul. 19, 2007

Related U.S. Application Data
(60) Provisional application No. 60/832,103, filed on Jul. 20, 2006.

(51) Int. Cl. G06F 17/00

(52) U.S. Cl. 463/47

(57) ABSTRACT

A protective device for a video player comprising a video screen, comprising a structure defining a main chamber, a support opening, and a screen opening. The protective device operates in first and second modes. In the first mode, at least a portion of the video player is located within the main chamber such that the video screen is within the main chamber. The structure protects the video player the video screen is at least partly visible through the screen opening when the protective device is in the first mode. In the second mode, at least a portion of the video player extends through the support opening such that the structure supports the video player such that the video screen is located outside the main chamber.

### RELATED APPLICATIONS

This application claims priority of U.S. Provisional Patent Application Ser. No. 60/832,103 filed Jul. 20, 2006, the contents of which are incorporated herein by reference.

### TECHNICAL FIELD

The present invention relates to protective devices for portable video players and, more particularly, to protective devices that function in a first mode in which the portable video device is carried and in a second mode in which the portable video device is supported for hands free viewing.

### BACKGROUND OF THE INVENTION

Many small, portable electronic devices have the ability to display video images. In some cases, a portable electronic device is specifically designed for the display of video images and is physically constructed to facilitate the viewing of video images. In other cases, the portable electronic device is very small and/or is not specifically constructed for the purpose of displaying video images. For example, small, portable electronic devices such as cellular telephones and music players are provided with video screens on which video images can be viewed but which are not specifically designed for viewing video images. Small portable electronic devices such as cellular telephones and music players are typically held by hand when used and have no structural components that support the video screen thereof at a desirable viewing angle and location.

Additionally, small, portable electronic devices are typically handheld and thus are susceptible to being dropped, scratched, or otherwise damaged during normal use. Accordingly, for most small, electronic devices, protective cases, holders, or the like have been developed to protect the device from damage.

The need exists for improved protective systems and methods for portable video playing devices that function in a first mode in which the device is protected from physical damage and in a second mode in which the portable device may be supported in a hands free manner at a desirable viewing angle and location.

### SUMMARY OF THE INVENTION

The present invention may take the form of a protective device for a video player comprising a video screen, comprising a structure defining a main chamber, a support opening, and a screen opening. The protective device operates in first and second modes. In the first mode, at least a portion of the video player is located within the main chamber such that the video screen is within the main chamber. The structure protects the video player the video screen is at least partly visible through the screen opening when the protective device is in the first mode. In the second mode, at least a portion of the video player extends through the support opening such that the structure supports the video player such that the video screen is located outside the main chamber.

### BRIEF DESCRIPTION OF THE DRAWINGS

FIG. 1 is a perspective, exploded view illustrating the insertion of a first example portable video player into a first example multi-mode protective device of the present invention;

FIG. 2 is a perspective view of the protective device of FIG. 1 carrying the first example video player in a first, carrying mode;

FIG. 3 is a perspective view of the first example protective device;

FIG. 4 is a rear elevation view of the first example protective device;

FIG. 5 is a bottom plan view of the first example protective device;

FIG. 6 is a side cutaway view taken along lines 6-6 in FIG. 4;

FIG. 7 is a side cutaway view of the first example protective device supporting the first example video player in a second, support mode;

FIG. 7A is a partial side cutaway view of an alternate configuration of the first example protective device operating in the second mode, where an engaging layer is formed on the protective device;

FIG. 8 is a rear elevation view of a second example multi-mode protective device of the present invention in a support mode, with a second example portable video player depicted in broken lines;

FIG. 9 is a side cutaway view taken along lines 9-9 in FIG. 8; and

FIG. 10 is a side cutaway view of the second example protective device supporting the second example video player in the support mode;

FIG. 11 is a rear elevation view of a third example multi-mode protective device of the present invention in a support mode, with the second example portable video player depicted in broken lines; and

FIG. 12 is a side cutaway view taken along lines 12-12 in FIG. 11 illustrating the third example protective device supporting the second example video player in the support mode.

### DETAILED DESCRIPTION OF THE INVENTION

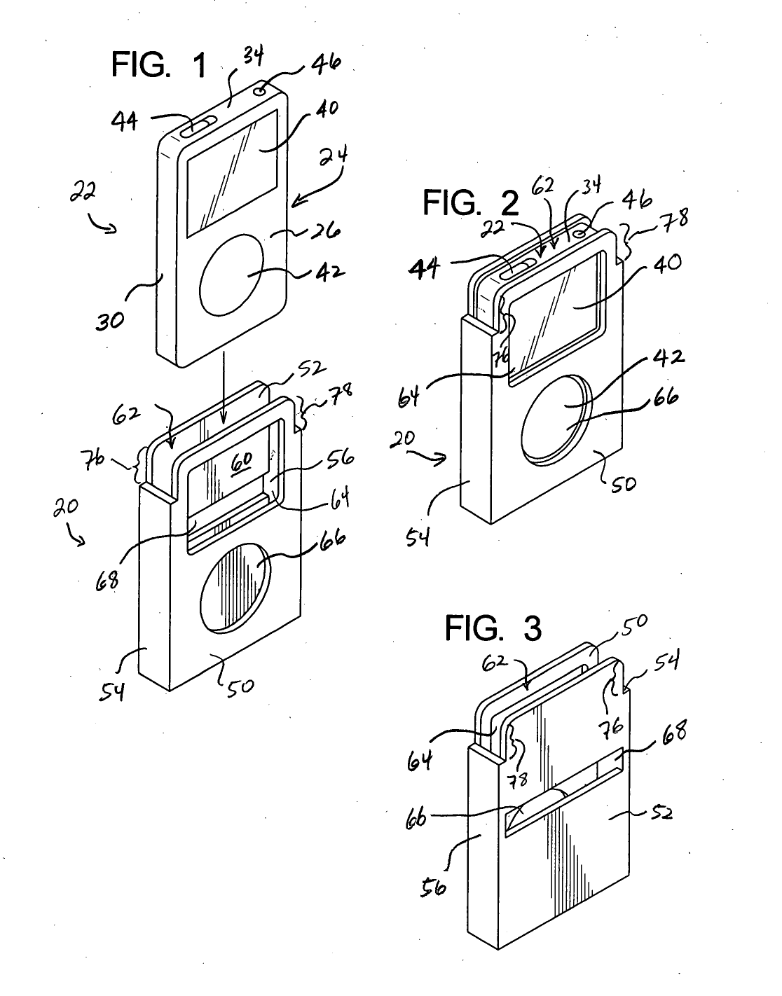

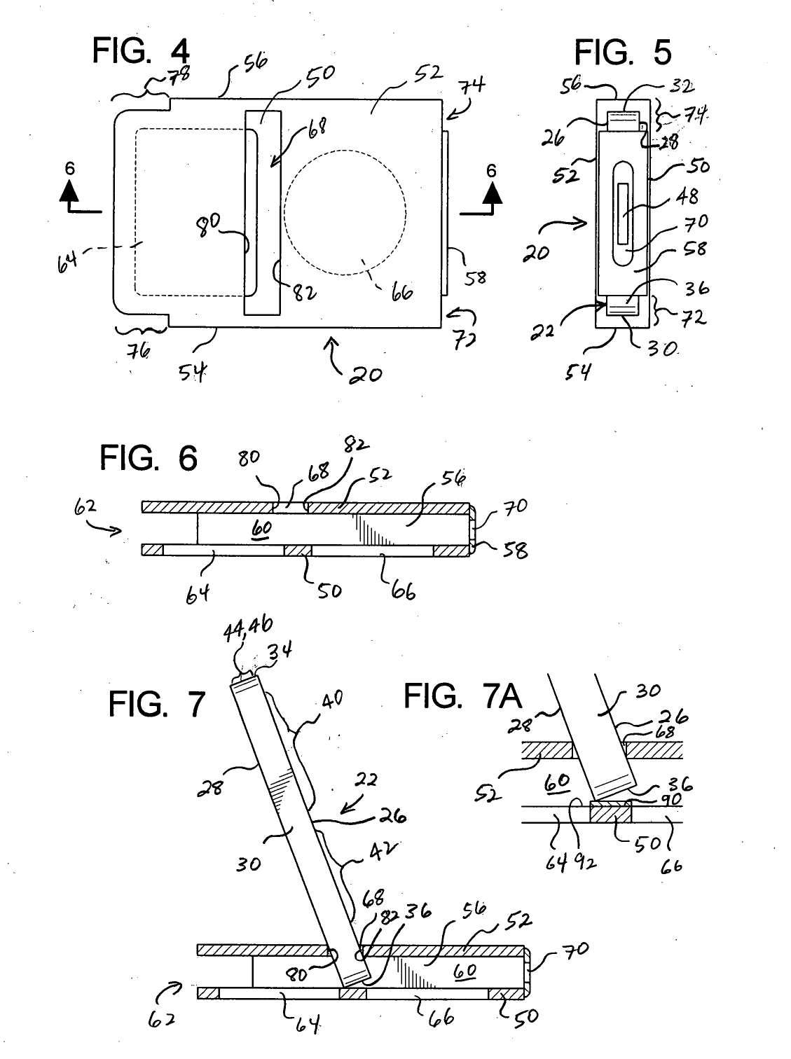

Referring initially to FIGS. 1-7 of the drawing, depicted at 20 therein is a first example of a multi-mode protective device constructed in accordance with, and embodying, the principles of the present invention. The protective device 20 is adapted to carry a first example portable video player 22 in a first or carrying mode as shown in FIG. 2 and in a second or support mode as shown in FIG. 7. The protective device 20 is thus a multi-mode device that allows the portable video player 22 to be carried in the first mode and supported for hands-free viewing in the second mode.

Referring initially to the example portable video player 22, the video player 22 is not per se part of the present invention. As will become apparent from the following discussion, the present invention may be used in connection with portable video players in other configurations and with other controls, features, and input/output devices.

The first example portable video player 22 is an iPod digital audio and video player comprising a housing 24 defining a front wall 26, a rear wall 28, first and second side walls 30 and 32, and first and second end walls 34 and 36. The first example portable video player 22 comprises a screen 40, first control 42, second control 44, first connector 46, and second connector 48. The screen 40 conventionally displays a user interface, graphics, and video. The first control 42 allows the user to enter commands in response to the user interface. The second control 44 is an ON/OFF slide switch. The first connector 46 allows the transfer of data between the video player 22 and another device such as a computer, docking station, digital camera, or the like. The second connector 48 is configured to allow an audio signal to be transmitted to a playback system such as headphones, amplifier, or the like.

In the model of iPod used as the first example digital video player, the screen 40 and first control 42 are mounted on the front wall 26, the second connector 48 is mounted on the second end wall 36, and the second control 44 and the first connector 46 are mounted on the first end wall 34. The construction and operation of the first example video player 22 is not essential to an understanding of the present invention and will be described herein only to the extent necessary for a complete understanding of the present invention.

When the protective device 20 is used in the first mode, the portable video player 22 is at least partly surrounded by the protective device 20 to inhibit damage to the video player 22 during transportation and normal use. In this first mode, screen 40 is visible and the first and second controls 42 and 44 and first and second connectors 46 and 48 are accessible. When the protective device 20 is used in the second mode, the portable video player 22 is supported in an upright orientation with the screen 40 at a desirable angle and orientation for viewing. In this second mode, the first and second controls 42 and 44 and the first connector 46 are accessible.

The details of the example protective device 20 will now be described in further detail. The protective device 20 comprises a front panel 50, a rear panel 52, a first side panel 54, a second side panel 56, and an end panel 58. The panels 50-58 define a player chamber 60. One end of the protective device 20 defines a main opening 62. A screen opening 64 and a control opening 66 are formed in the front panel 50. A support opening 68 is formed in the rear panel 52. A connector opening 70 is formed in the end panel 58. First and second corner openings 72 and 74 are formed in the end panel 58, while first and second corner notches 76 and 78 are formed in the first and second side panels 54 and 56, respectively. First and second support edges 80 and 82 are defined by the rear panel 52 on opposite sides of the support opening 68.

As perhaps best shown in FIGS. 1 and 2, when the protective device 20 is used in its first, carrying mode, the example video player 22 is inserted into the player chamber 60 through the main opening 62 such that the front wall 26 engages the front panel 50 and the second end wall 36 engages the end panel 58. In this first mode of using the device 20, the screen 40 is visible through the screen opening 64, the first control 42 is accessible through the control opening 66, the second control 44 and first connector 46 are accessible through the main opening 62, and the second connector 48 is accessible through the connector opening 70.

In the first mode, the protective device 20 protects the video player 22 and also allows the player 22 to be used in a conventional manner. The video player 22 may be removed from the protective device 20 by gripping the first and/or second side walls 30 and 32 through the corner notches 76 and/or 78 and/or by pushing up on the second end wall 36 through one or both of the corner openings 72 and 74.

When the protective device 20 is used in the second mode, the second end wall 36 of the player 22 is displaced through the support opening 68 in the rear panel 52 until the second end wall 36 engages the front panel 50 as shown in FIG. 7. At this point, the video player 22 is released such that the front and rear walls 26 and 28 thereof engage the support edges 80 and 82 of the rear panel 52.

With the video player engaging the front panel 50 and the support edges 80 and 82 in this second mode, the video player 22 is held at a desirable viewing angle with respect to the rear panel 52. The protective device 20 may be placed on a support surface or otherwise supported in a horizontal manner as shown in FIG. 7 to allow hands-free viewing of the screen 40. In addition, the first control 42, the second control 44, and the first connector 46 are all accessible in this second mode, as generally indicated in FIG. 7.

Referring now for a moment to FIG. 7A of the drawing, depicted therein is an optional support layer 90 that may be applied to an inner surface 92 of the front wall 50. The example support layer 90 is formed from a relatively high friction material that will not damage the finish of the video player 22. A rubber, rubber-like, or gel-like material, perhaps with a tacky or gummy surface, may be used to increase friction between the video player 22 and the inner surface 92 of the front wall 50 while also not damaging the finish of the video player 22. The increased friction provided by the example support layer 90 may allow more control of the viewing angle between the video player 22 and the rear surface 52. Other examples of support layers, perhaps including notches or seats that correspond to different viewing angles, may be used in place of the example support layer 90.

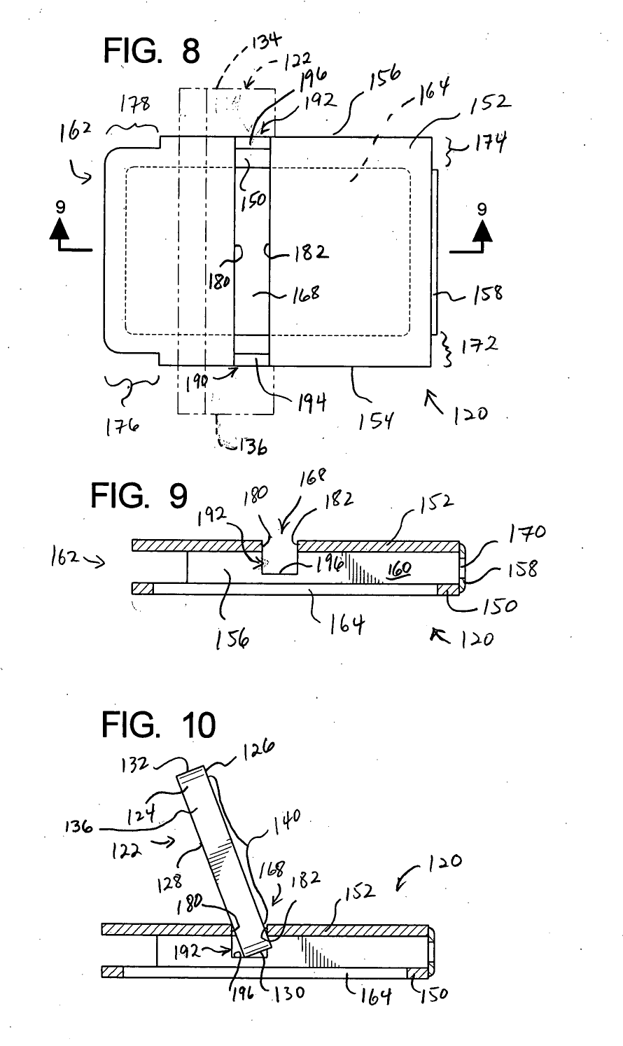

Turning now to FIGS. 8-10 of the drawing, depicted at 120 therein is a second example of a multi-mode protective device constructed in accordance with, and embodying, the principles of the present invention. The second example protective device 120 is adapted to carry a second example portable video player 122 in a first or carrying mode (similar to FIGS. 2 and 5 above) and in a second or support mode as represented in FIGS. 8 and 10. The protective device 120 is thus also a multi-mode device that allows the portable video player 122 to be carried in the first mode and supported for hands-free viewing in the second mode.

Referring initially to the example portable video player 122, the video player 122 is not per se part of the present invention. As with the first example protective device 20, the present invention may be used in connection with portable video players in other configurations and with other controls, features, and input/output devices.

The first example portable video player 122 is an iPod digital audio and video player comprising a housing 124 defining a front wall 126, a rear wall 128, first and second side walls 130 and 132, and first and second end walls 134 and 136. The first example portable video player 122 comprises a screen 140 and one or more controls and/or connectors (not shown). The example screen 140 conventionally displays a user interface, graphics, and video. In the second example video player 122, the screen 140 extends along almost the entire front wall 126 and is touch sensitive to form a control that allows user input in response to the user interface. The exact configuration of the controls and connectors is not important to the principles of the present invention except as will be described below.

In the model of iPod used as the second example digital video player 122, the screen 140 is mounted on the front wall 126. The screen is typically viewed with its long dimension horizontally arranged. The first side wall 130 thus lies under the screen 140, while the second side wall 132 is above the screen 140. The construction and operation of the second example video player 122 is not essential to an understanding of the present invention and will be described herein only to the extent necessary for a complete understanding of the present invention.

When the protective device 120 is used in the first mode, the portable video player 122 is at least partly surrounded by the protective device 120 to inhibit damage to the video player 122 during transportation and normal use. In this first mode, screen 140 is visible. When the protective device 120 is used in the second mode, the portable video player 122 is supported in an upright orientation with the screen 140 at a desirable angle and orientation for viewing. In the first and second modes, any other controls and connectors defined by the portable video player 122 should be accessible as necessary to operate the video player in that mode.

The details of the second example protective device 120 will now be described in further detail. The protective device 120 comprises a front panel 150, a rear panel 152, a first side panel 154, a second side panel 156, and an end panel 158. The panels 150-158 define a player chamber 160. One end of the protective device 120 defines a main opening 162. A screen opening 164 is formed in the front panel 150. A support opening 168 is formed in the rear panel 152. A connector opening 170 is formed in the end panel 158. First and second corner openings 172 and 174 are formed in the end panel 158. First and second corner notches 176 and 178 are formed in the side panels 154 and 156. First and second support edges 180 and 182 are defined by the rear panel 152 on opposite sides of the support opening 168. First and second side notches 190 and 192 are formed in the side panels 154 and 156, respectively. First and second support surfaces 194 and 196 are formed by the first and second side panels 154 and 156 at the first and second side notches 190 and 192, respectively.

The protective device 120 is used in its first, carrying mode with the front wall 126 engaging the front panel 150 and the second end wall 136 engaging the end panel 158. In this first mode of using the device 120, the screen 140 is visible through the screen opening 164. Additionally, any other controls or connectors formed on or defined by the video player are accessible as desirable when operating the video player 122 with the protective device 120 in this first mode. In the first mode, the protective device 120 protects the video player 122 and also allows the player 122 to be used in a conventional manner.

When the protective device 120 is used in the second mode, the first side wall 130 thereof is displaced through the support opening 168 in the rear panel 152 until the first side wall 130 engages the side panels 154 and 156 as shown in FIG. 10. At this point, the video player 122 is released such that the front and rear walls 126 and 128 thereof engage the first and second support edges 180 and 182 of the rear panel 152 and the first side edge 130 engages the first and second support surfaces 194 and 196.

With the video player engaging the front panel 150 and side panels 154 and 156 in this second mode, the video player 122 is held at a desirable viewing angle with respect to the rear surface 152. The protective device 120 may be placed on a support surface or otherwise supported in a horizontal manner to allow hands-free viewing of the screen 140. In addition, any controls or connectors should be accessible in this second mode.

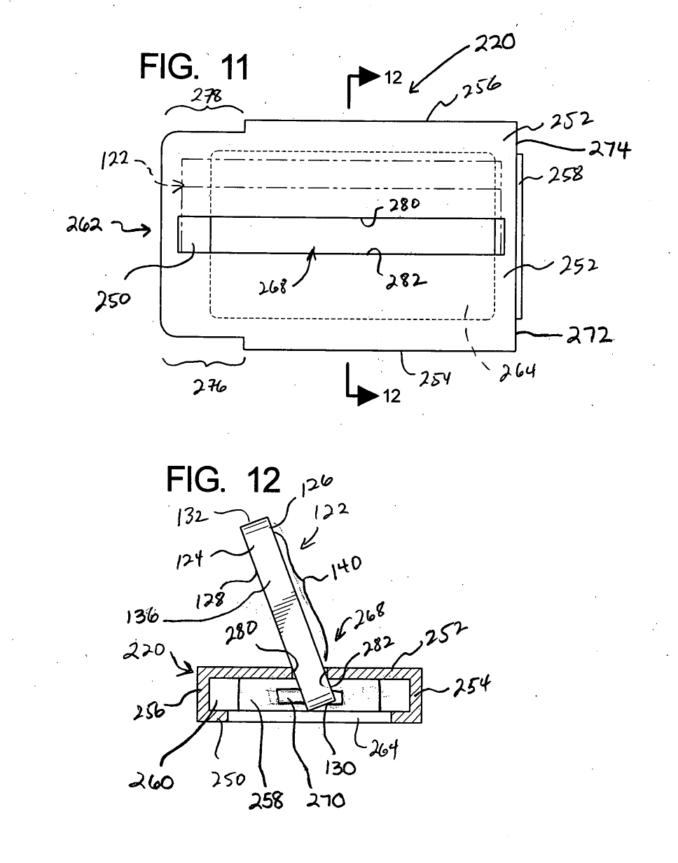

Turning now to FIGS. 11 and 12 of the drawing, depicted at 220 therein is a third example of a multi-mode protective device constructed in accordance with, and embodying, the principles of the present invention. The third example protective device 220 is adapted to carry the second example portable video player 122 described above in a first or carrying mode and in a second or support mode as represented in FIGS. 11 and 12. The protective device 220 is thus also a multi-mode device that allows the portable video player 222 to be carried in the first mode and supported for hands-free viewing in the second mode.

When the protective device 220 is used in the first mode, the portable video player 122 is at least partly surrounded by the protective device 220 to inhibit damage to the video player 122 during transportation and normal use. In this first mode, screen 140 is visible. When the protective device 220 is used in the second mode, the portable video player 122 is supported in an upright orientation with the screen 140 at a desirable angle and orientation for viewing. In the first and second modes, any other controls and connectors defined by the portable video player 122 should be accessible as necessary to operate the video player in that mode.

The details of the second example protective device 220 will now be described in further detail. The protective device 220 comprises a front panel 250, a rear panel 252, a first side panel 254, a second side panel 256, and an end panel 258. The panels 250-258 define a player chamber 260. One end of the protective device 220 defines a main opening 262. A screen opening 264 is formed in the front panel 250. A support opening 268 is formed in the rear panel 252. A connector opening 270 is formed in the end panel 258. First and second corner openings 272 and 274 are formed in the end panel 258. First and second corner notches 276 and 278 are formed in the side panels 254 and 256. First and second support edges 280 and 282 are defined by the rear panel 252 on opposite sides of the support opening 268.

The protective device 220 is used in its first, carrying mode with the front wall 126 engaging the front panel 250 and the second end wall 136 engaging the end panel 258. In this first mode of using the device 220, the screen 140 is visible through the screen opening 264. Additionally, any other controls or connectors formed on or defined by the video player are accessible as desirable when operating the video player 122 with the protective device 220 in this first mode. In the first mode, the protective device 220 protects the video player 122 and also allows the player 122 to be used in a conventional manner.

When the protective device 220 is used in the second mode, the first side wall 130 thereof is displaced through the support opening 268 in the rear panel 252 until the first side wall 130 engages the front panel 250 as shown in FIG. 12. At this point, the video player 122 is released such that the front and rear walls 126 and 128 thereof engage the first and second support edges 280 and 282 of the rear panel 252.

With the video player engaging the front panel 250 and rear panel 252 this second mode, the video player 122 is held at a desirable viewing angle with respect to the rear surface 252. The protective device 220 may be placed on a support surface or otherwise supported in a horizontal manner to allow hands-free viewing of the screen 140. In addition, any controls or connectors should be accessible in this second mode.

As generally indicated above, a protective device of the present invention may be configured based on the particular form factor and control and connector layout of a particular video player.

What is claimed is:

1. A protective device for a video player comprising a video screen, comprising:
a structure defining a main chamber, a support opening, and a screen opening; wherein
the protective device operates in a first mode in which
at least a portion of the video player is located within the main chamber such that the video screen is within the main chamber,
the structure protects the video player, and
the video screen is at least partly visible through the screen opening; and
the protective device operates in a second mode in which at least a portion of the video player extends through the support opening such that the structure supports the video player such that the video screen is located outside the main chamber.

2. A protective device as recited in claim 1, in which the structure further defines a main opening that allows at least a portion of the video player to be inserted into the main chamber to place the protective device in the first mode.

3. A protective device as recited in claim 1, in which the structure comprises at least one panel, where the video screen extends at a viewing angle with respect to the at least one panel when the protective device operates in the second mode.

4. A protective device as recited in claim 1, in which the video player further comprises at least one control button, where the structure further defines at least one control opening configured to allow access to the at least one control button when the protective device operates in the first mode.

5. A protective device as recited in claim 1, in which the video player further comprises at least one control button, where the at least one control button is located outside the main chamber when the protective device operates in the second mode.

6. A protective device as recited in claim 1, in which the video player further comprises at least one connector, where the structure further defines at least one connector opening configured to allow access to the at least one connector when the protective device operates in the first mode.

7. A protective device as recited in claim 1, in which the structure comprises a front panel and a rear panel, wherein:
the screen opening is formed in the front panel; and
the support opening is formed in the rear panel.

8. A protective device as recited in claim 4, in which the structure further comprises a front panel and a rear panel, wherein:
the screen opening and at least one control opening are formed in the front panel; and
the support opening is formed in the rear panel.

9. A protective device as recited in claim 6, in which the structure further comprises a front panel, a rear panel, and an end panel, wherein:
the screen opening is formed in the front panel;
the support opening is formed in the rear panel; and
the at least one connector opening is formed in the end panel.

10. A protective device as recited in claim 1, in which the structure comprises at least one support surface, wherein:
the at least one support surface defines at least a portion of the support opening; and
the at least one support surface supports the video player when the protective device operates in the second mode.

11. A method of protecting and supporting a video player comprising a video screen, comprising the steps:
providing a structure defining a main chamber, a support opening, and a screen opening;
locating at least a portion of the video player within the main chamber such that
the video screen is within the main chamber and at least partly visible through the screen opening, and
the structure protects the video player; and
extending at least a portion of the video player through the support opening such that the structure supports the video player such that the video screen is located outside the main chamber.

12. A method as recited in claim 11, in which:
the step of providing the structure further comprises the step of defining a main opening; and
the step of locating at least a portion of the video player within the main chamber comprises the step of inserting at least a portion of the video player into the main chamber.

13. A method as recited in claim 11, in which:
the step of providing the structure further comprises the step of providing at least one panel; and
the step of extending at least a portion of the video player through the support opening comprises the step of extending the video screen at a viewing angle with respect to the at least one panel.

14. A method as recited in claim 11, in which:
the video player further comprises at least one control button;
the step of providing the structure further comprises the step of defining at least one control opening; and
the step of locating the at least a portion of the video player within the main chamber comprises the step of allowing access to the at least one control button through the at least one control opening.

15. A method as recited in claim 11, in which:
the video player further comprises at least one control button;
the step of providing the structure further comprises the step of defining at least one control opening configured to allow access to the at least one control button; and
the step of extending at least a portion of the video player through the support opening comprises the step of locating the at least one control button outside the main chamber.

16. A method as recited in claim 11, in which:
the video player further comprises at least one connector; and
the step of providing the structure further comprises the step of defining at least one connector opening; and
the step of locating the at least a portion of the video player within the main chamber comprises the step of allowing access to the at least one connector through the at least one connector opening.

17. A method as recited in claim 11, in which the step of providing the structure further comprises the steps of:
providing a front panel defining the screen opening; and
providing a rear panel defining the support opening.

18. A method as recited in claim 11, in which the step of providing the structure further comprises the steps of:
providing a front panel defining the screen opening and the at least one control opening; and
providing a rear panel defining the support opening.

19. A protective device as recited in claim 11, in which the video player further comprises at least one connector, in which:
the step of providing the structure further comprises the steps of providing
a front panel defining the screen opening,
a rear panel defining the support opening, and
a rear panel defining at least one connector opening; and
the step of locating at least a portion of the video player within the main chamber comprises the steps of allowing access to the at least one connector through the at least one connector opening.

20. A protective device as recited in claim 1, in which:
the step of providing the structure comprises the step of forming at least one support surface thereon, where the at least one support surface defines at least a portion of the support opening; and
the step of extending at least a portion of the video player through the support opening comprises the step of causing the video player to engage the support surface.

21. A protective device for a video player comprising a video screen, comprising:
a structure comprising a front panel, a rear panel, a first side panel,
a second side panel, and an end panel, where
the front panel, rear panel, first side panel, second side panel, and end panel define defining a main chamber and a main opening,
a screen opening is formed in the front panel, and
a support opening is formed in the rear panel; wherein
the protective device operates in a first mode in which
at least a portion of the video player is inserted into the main chamber through the main opening such that the video screen is within the main chamber,
the structure protects the video player, and
the video screen is at least partly visible through the screen opening; and
the protective device operates in a second mode in which at least a portion of the video player is inserted into the main chamber through the support opening such that the structure supports the video player such that the with the video screen is located outside the main chamber and extends at a viewing angle with respect to the rear panel.

22. A protective device as recited in claim 21, in which the video player further comprises at least one control button, where the structure further defines at least one control opening configured to allow access to the at least one control button when the protective device operates in the first mode.

23. A protective device as recited in claim 21, in which the video player further comprises at least one control button, where the at least one control button is located outside the main chamber when the protective device operates in the second mode.

24. A protective device as recited in claim 21, in which the video player further comprises at least one connector, where the end panel defines at least one connector opening configured to allow access to the at least one connector when the protective device operates in the first mode.

25. A protective device as recited in claim 21, in which the first and second side panels define first and second support notches, wherein:
the first and second support notches define at least a portion of the support opening; and
a portion of the video player lies within the first and second support notches when the protective device operates in the second mode.
